(19) United States
(12) Patent Application Publication
(10) Pub. No.: US 2025/0173600 A1
(43) Pub. Date: May 29, 2025

(54) SYSTEM AND METHOD FOR MODELLING TASK FEATURES

(71) Applicant: Centre for Intelligent Multidimensional Data Analysis Limited, Pak Shek Kok (HK)

(72) Inventors: Tak Wu Sam Kwong, Pak Shek Kok (HK); Yuxuan Luo, Pak Shek Kok (HK); Runmin Cong, Pak Shek Kok (HK)

(21) Appl. No.: 18/519,588

(22) Filed: Nov. 27, 2023

(51) Int. Cl. G06N 20/00

(52) U.S. Cl. CPC G06N 20/00

(57) ABSTRACT

A system and method for modelling task features for continual learning including a task input gateway arranged to receive a series of task samples, a task feature extraction engine arranged to process the received task samples and extract task invariant and task variant features, a replay buffer configured to store a subset of previous tasks as a representative of previous tasks that were processed by the system, a task classification engine arranged to perform a task relation process to determine task relations between tasks, wherein the task relations are based at least partly on a subset of previous tasks accessed from the replay buffer, an output module configured to output the task relations to be used on continual learning, and wherein the replay buffer is updated by storing a subset of the outputs.

### TECHNICAL FIELD

The present invention relates to a system and method for modelling task features, in particular but not limited to, a system and method for modelling task features for continual learning applications.

### BACKGROUND

Existing continual learning methods that are employed in machine learning applications can be broadly categorised into three categories: 1) regularization based methods, 2) structure based methods and 3) Replay based methods (i.e., memory based methods).

Regularisation based methods add constraints or penalties to the loss function, gradient or input samples during training. One example approach proposes to add a penalty term to restrict a model's important weight from changing too much. Another approach proposes to evaluate the importance of weights inspired by synaptic intelligence. In this approach, the regularization term used may reduce the search space of parameters when locating minima, which results in a dilemma between stability and plasticity. Another regularization approach proposes to measure the uncertainty of each node for new tasks and apply two extra regularization terms for plasticity and stability. Regularization terms on the gradient direction extend the search space and adapt the model to the new tasks. One example approach utilises an orthogonal weights modification (OWM) algorithm to decompose the new task gradient into the old task subspace to maintain performance on the old tasks. Another approach proposes to decompose the new task gradient and update the orthogonal gradient to the previous task. The goal of regularization based methods is to learn new tasks with minimal impact on the performance of previous tasks. However, these methods face a trade off between stability and plasticity, and may suffer from forgetting problems when the number of tasks increases.

Structure based methods aim to learn task specific classifiers or model parameters. Depending on whether the model structure expands during training, they can be categorized into dynamic or fixed network structure methods. Dynamic methods, e.g., DEN, can add neurons to the network dynamically when the previous model structure and knowledge is insufficient to learn the new task. One example approach of structure based methods propose using an expert gate to select the most relevant previous task to train the new task. The Learn-to-Grow framework attempt to find the optimal model structure for each task during learning. In contrast, fixed network methods generally build a large network structure that can provide enough neurons for all task training. In one example an attention mechanism to identify and preserve important neurons while masking out irrelevant ones during new task training. Another approach proposes to preserve bit level information and estimate neuron's information gain to update parameters. A further approach proposes a method to prevent forgetting by treating convolution filters as important parameters. These structure based methods often select certain filters to be preserved for previous tasks and prevent them from being updated while training new tasks. Extra neurons and parameters provide model capacity for a new task. However, this can require lot of computational resource due to the dynamic addition of new neurons.

Replay based methods draw inspiration from human learning and reviewing to prevent forgetting. One example approach utilises distance based classification to select the closest samples to the class center for replay buffer. Another addition to this approach selects the most representative samples for the replay buffer. Gradient Episodic Memory (GEM) is an example approach of a replay based method. The GEM approach proposes to measure the memory buffer during the new task training to prevent the increasing loss of the previous task. Another example approach proposes to store the class prototypes of previous tasks in the buffer. Another further example proposes using VAEGAN to generate samples in the latent space based on the previous task latent encoding as the replay buffer. Replay based methods provide a reference of the previous to the model by re-exposing the model to the previous task samples, thereby helping the model to reduce forgetting the old tasks while learning new tasks.

Contrastive learning is a further approach that is used to train machine learning models. The availability of the labelled data is critical for deep learning. Contrastive learning methods have been proposed as self supervised learning schemes that make use of unlabelled data. Deep InfoMax is an example approach that maximises the mutual information between a clip of audio and its context audio, providing one approach to contrastive learning. MoCo is another example scheme that learns the input representation and its relationship to other inputs by determining whether they are similar or different. Instead of learning the semantic class of an input, the model identifies whether two inputs are the same or different. If they are the same, their latent representations should be very close. There are other contrastive methods. While these methods or approaches still require large scale unlabelled data to train the model, they offer a good pretrained feature extractor.

Some of the existing approaches to continual learning and contrastive learning have mainly focussed on instance level learning and have not explored cross task information. The current continual learning and contrastive learning methods can require a lot of computing resources due to the focus on instance level learning. Some examples of these methods also require large datasets for learning which can also make it resource intense.

### SUMMARY OF THE INVENTION

In accordance with a first aspect, the present invention relates to a system for modelling task features for continual learning comprising:
a task input gateway arranged to receive a series of task samples,
a task feature extraction engine arranged to process the received task samples and extract task invariant and task variant features,
a replay buffer configured to store a subset of previous tasks as a representative of previous tasks that were processed by the system,
a task classification engine arranged to perform a task relation process to determine task relations between tasks, wherein the task relations are based at least partly on a subset of previous tasks accessed from the replay buffer.
an output module configured to output the task relations to be used on continual learning, and wherein the replay buffer is updated by storing a subset of the outputs.

In one example the task classification engine is configured to decouple task invariant features and task variant features based on the task relations.

In one example the task classification engine is configured to:
capture inner task relations based on processing the task invariant and task invariant features,
construct cross task relations based on the subset of previous tasks accessed from the replay buffer.

In one example the task classification engine is configured to decouple task invariant features and task variant features based at least one of the inner task relations and cross task relations.

In one example the system is configured to determine contrastive learning pairs, wherein the inner task relations and the cross task relations are defined by the determined contrastive learning pairs.

In one example the task classification engine is configured to determine multiple contrasts to decompose task invariant features and task variant features.

In one example the task classification engine is configured to determine three types of contrast to decompose task invariant features and task variant features.

In one example the system comprises:
a task invariant feature extractor configured to extract task invariant features from the received series of task samples,
a task variant feature extractor configured to extract task variant features from the received series of task samples,

In one example the task classification engine is configured to:
extract task invariant and task variant features by applying at least one or more constraints wherein the constraints comprise:
   establishing a boundary between the invariant and variant features
   generating similar task invariant features across tasks
   establishing distinct boundaries between task variant features from each task or class.

In one example the task classification engine is configured to decouple the task invariant and task variant features based on:
determining an orthogonal distance loss function,
applying the orthogonal distance loss function to the identified task invariant and task variant features,
determining contrastive learning pairs of features,
utilise the learning pairs to further decouple the task invariant and task variant features.

In one example the task classification engine is configured to determine inner task relations, wherein the inner task relations are determined based on the learning pairs that decouple the task invariant and task variant features while clustering the invariant features together regardless of class.

In one example the task classification engine is further configured to:
apply a classifier to the task variant features wherein the classifier is configured to group task variant features for a particular class together,
determine learning pairs of task variant features for each defined class.

In one example the task classification engine is configured to:
extract a feature of a sample of previous tasks from the replay buffer,
determine additional updated learning pairs of task variant features, task invariant features and task invariant and variant features based on the feature from the replay buffer,
determine a cross task relations based on the updated learning pairs.

In one example the inner task relations are defined as an contrastive loss function, wherein the inner task relation function is:

$${L}_{sp} = {\sum }_{i ∈ I} \frac{- 1}{\vert pp \vert} {\sum }_{pp} \frac{exp ( {x}_{i}^{′} \cdot {x}_{pp}^{′} / τ )}{{\sum }_{a ∈ \{ pp , np )} exp ( {x}_{i}^{′} \cdot {x}_{a}^{′} / τ )} ,$$

and;
wherein xₚₚ′ is the positive sample, I is all samples, pp is the positive pairs subset, |pp| is the total number of pp, τ is the temperature index and np is a negative pairs,
wherein pp is a set of learning pairs from task invariant features and np is a set of learning pairs between task invariant and task variant features.

In one example, the contrastive loss function is an example of an orthogonal distance loss function.

In one example the cross task relations are defined by learning pairs, wherein the learning pairs comprise np, pp, and vp, wherein np is a set of learning pairs between task invariant and task variant features, pp is a set of learning pairs from task invariant features, and vp represents learning pairs of task variant features, and;
wherein each set of learning pairs comprises additional terms,
np include extra learning pairs (x_{s,c=i}′, x_{p,m}′), pp includes (x_{s,c=i}′, x_{s,m}′) and vp includes negative pairs (x_{p,c=i}′, x_{p,m}′), wherein m represents a feature from the replay buffer.

In one example the modelling task features comprises identifying task invariant and task variant features based on the inner task relations and cross task relations, wherein the system provides a model for learning based on resolving tasks into task invariant features and task variant features.

In one example the system comprises:
a classifier arranged to classify tasks based on a specific class
a discriminator arranged to discriminate the differentiate between the task invariant and variant features of each task.

In accordance with a second aspect, the present invention relates to a computer implemented method for modelling task features for continual learning comprising the steps of:
receiving one or more task samples,
extract task invariant and task variant features from the received task samples,
receiving a subset of previous tasks from a replay buffer,
performing a task relation process to:
   capture inner task relations based on processing the task invariant and task invariant features,
   construct cross task relations based on the subset of previous tasks accessed from the replay buffer, and;
   decouple task invariant features and task variant features based at least one of the inner task relations and cross task relations.

In one example the computer implemented method comprises the additional step of:
extracting task invariant and task variant features by applying at least one or more constraints wherein the constraints comprise:
   establishing a boundary between the invariant and variant features
   generating similar task invariant features across tasks
   establishing distinct boundaries between task variant features from each task or class.

In one example the computer implemented method comprises:
determining the inner task relations based on the learning pairs that decouple the task invariant and task variant features while clustering the invariant features together regardless of class,
grouping task variant features for a particular class together,
determining learning pairs of task variant features for each defined class.
extracting a feature of a sample of previous tasks from the replay buffer,
determining additional updated learning pairs of task variant features, task invariant features and task invariant and variant features based on the feature from the replay buffer, and;
   determining a cross task relations based on the updated learning pairs.

In accordance with a third aspect, the present invention relates to a data processing apparatus comprising a processor and a memory unit, or one or more hardware and/or software modules for carrying out the method modelling task features in continual learning.

In accordance with a fourth aspect, the present invention relates to a computer program comprising instructions which, when the program is executed by a computer, cause the computer to carry out the method of modelling task features for continual learning as described above. Optionally, the method may be the method described herein.

In another example the computer program may comprise instructions that cause a computer to carry out the method of modelling task features in continual learning as described herein.

In accordance with a fifth aspect, the present invention relates to a computer readable medium comprising instructions which, when executed by a computer, cause the computer to carry out the method of modelling task features for continual learning as described herein.

The term “comprising” (and its grammatical variations) as used herein are used in the inclusive sense of “having” or “including” and not in the sense of “consisting only of”.

It is to be understood that, if any prior art information is referred to herein, such reference does not constitute an admission that the information forms a part of the common general knowledge in the art, in Australia or any other country

### BRIEF DESCRIPTION OF THE DRAWINGS

Embodiments of the present invention will now be described, by way of example, with reference to the accompanying drawings in which:

FIG. 1 illustrates a system for modelling task features for continual learning.

FIG. 2 illustrates a schematic diagram of a computing system that can be used implement with or as part of the system.

FIG. 3 illustrates a method for modelling task features for continual learning.

FIG. 4 illustrates a further example of system for modelling task features for continual learning.

### DETAILED DESCRIPTION OF THE PREFERRED EMBODIMENTS

The present invention relates to a system and method for continual learning, in particular for improved continual learning. The present invention relates to a system and method for knowledge capture for use continual learning. Knowledge capture relates to modelling task features.

The invention, in particular relates, to a system and method for modelling task features that are used for continual learning. The system and method for modelling task features are configured to classify tasks into task invariant and task variant features for continual learning. The task invariant and task variant features capture the generalised and task specific knowledge that is used in continual learning. The system and method for knowledge capture for continual learning provides machine learning network (i.e., a machine learning model) that can be applied in continual learning tasks. The task invariant and task variant features are decoupled from each other in distance and similarity which can enhance feature decomposition. The system and method are configured to construct inner task relations and cross task relations to further decouple the task invariant and task variant features in order to augment feature quality and learnability of the model.

The proposed framework utilizes all-round and multi-level contrasts to decouple task-invariant and variant features in the training sequences of continual learning tasks. The construction of inner-task and cross-task relations effectively extracts well-distributed invariant and variant features that improve the classification task and alleviate the forgetting problem in continual learning.

The system for modelling task features for continual learning is configured to model i.e., construct inner task relations and cross task relations. The inner task and cross task relations are contrastive relations. The inner task relations and cross task relations are configured to decouple task invariant and task variant features for continual learning. The task-invariant and variant features aim to capture the generalized and task-specific knowledge in the continual learning process. The proposed system and method for modelling task features is configured to enhance the quality of task invariant and task variant features with a clear classification margin.

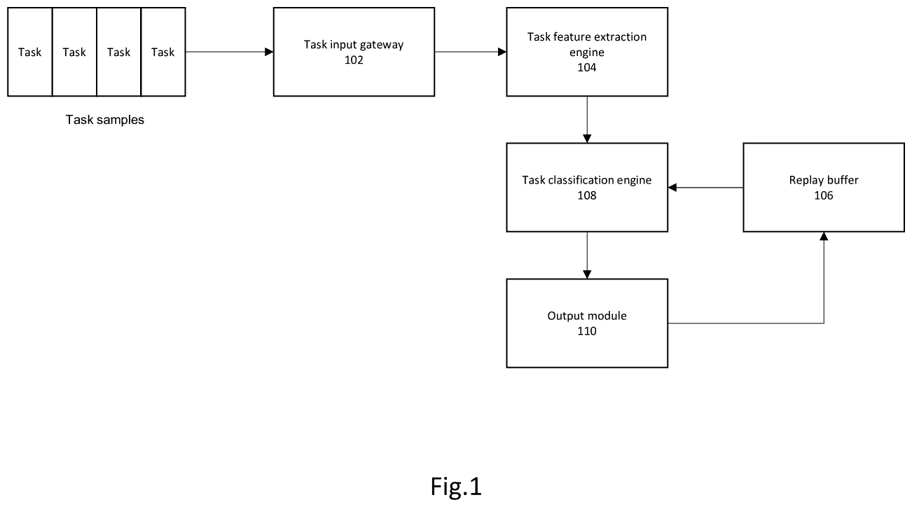

Referring to FIG. 1, an embodiment of the present invention is illustrated. This embodiment is arranged to provide a system and method for modelling task features for continual learning comprising:
a task input gateway arranged to receive a series of task samples,
a task feature extraction engine arranged to process the received task samples to, decompose each task sample and extract task invariant and task variant features,
a replay buffer configured to store a subset of previous tasks as a representative of previous tasks that were processed by the system, and;
a task classification engine arranged to: capture inner task relations based on processing the task invariant and task invariant features, construct cross task relations based on the subset of previous tasks accessed from the replay buffer, an output module configured to output the task relations and/or decouple task invariant features and task variant features to be used on continual learning, and wherein the replay buffer is updated by storing a subset of the outputs.

Additionally, the task classification engine is configured to: capture inner task relations based on processing the task invariant and task invariant features, and construct cross task relations based on the subset of previous tasks accessed from the replay buffer. The task classification engine may be further configured to decouple task invariant features and task variant features based at least one of the inner task relations and cross task relations.

Referring to FIG. 1, the system 100 for modelling task features comprises a task input gateway 102 arranged to receive a series of task samples. The task samples may be a plurality of tasks that need to be resolved, i.e., processed by the system. The system provides a manner to identify task features and decompose tasks into specific constituent elements, and classify them to make task processing easier, simpler and faster.

The system further comprises a task feature extraction engine 104 arranged in communication with the task input gateway 102. The task extraction engine 104 may be arranged to process the received task samples to, decompose each task sample and extract task invariant and task variant features. The task feature extraction engine 104 may be configured to identify task invariant features and task variant features. Task invariant features may be features of a task that do not change from task to task. Task variant features are features of a task that change from task to task and also may vary from class to class i.e., within classes of tasks.

The system 100 further comprises a replay buffer 106 configured to store a subset of previous tasks as a representative of previous tasks that were processed by the system. The replay buffer 106 may be a memory element or may be a database or other data storage structure.

The system 100 comprises a task classification engine 108 that is in communication with the task feature extraction engine. The task classification engine 108 may be arranged to perform a task relation process to determine task relations between tasks, wherein the task relations are based at least partly on a subset of previous tasks accessed from the replay buffer 106.

The task classification engine 108 is configured to decouple task invariant features and task variant features based on the task relations. The task classification engine is further configured to: capture inner task relations based on processing the task invariant and task invariant features, and construct cross task relations based on the subset of previous tasks accessed from the replay buffer. The task classification engine 108 is configured to decouple task invariant features and task variant features based at least one of the inner task relations and cross task relations.

In one example the task classification engine 108 is configured to determine multiple contrasts to decompose task invariant features and task variant features. The task classification engine 108 is configured to extract task invariant and task variant features by applying at least one or more constraints. The constraints may comprise one or more of:
establishing a boundary between the invariant and variant features
generating similar task invariant features across tasks
establishing distinct boundaries between task variant features from each task or class.

The task classification engine 108 is configured to decouple the task invariant and task variant features based on: determining an orthogonal distance loss function, applying the orthogonal distance loss function to the identified task invariant and task variant features, determining contrastive learning pairs of features. The classification engine 108 is configured to utilise the learning pairs to further decouple the task invariant and task variant features.

The system 100 may optionally comprise a task invariant feature extractor configured to extract task invariant features from the received series of task samples. The system 100 may further optionally comprise a task variant feature extractor that is configured to extract task invariant features from the received series of task samples. The task classification engine 108 is configured to determine inner task relations, wherein the inner task relations are determined based on the learning pairs that decouple the task invariant and task variant features while clustering the invariant features together regardless of class.

The task classification engine 108 is configured to extract a feature of a sample of previous tasks from the replay buffer, determine additional updated learning pairs of task variant features, task invariant features and task invariant and variant features based on the feature from the replay buffer, and determine a cross task relations based on the updated learning pairs.

The system 100 is configured to determine contrastive learning pairs, wherein the inner task relations and the cross task relations are defined by the determined contrastive learning pairs.

The system 100 comprises an output module 110 configured to output the task relations to be used on continual learning, and wherein the replay buffer 106 is updated by storing a subset of the outputs. The components of the system 100 may be software modules that may be part of a larger software application. In another example one or more of the components of the system 100 may be hardware modules such as for example integrated circuits or microprocessors or FPGAs or ASICs or a combination thereof. The system 100 as described in reference to FIG. 1 may comprise a combination of software and hardware modules. In one example the system 100 may be implemented in a computer i.e., a computing apparatus, computing device or computing system.

In one example the system 100 may define components of a machine learning system that is trained for continual learning. The system 100 may be configured to implement a method for modelling task features. The system 100 is configured to define the process flow for a machine learning task e.g., a computer vision task where input samples (i.e., task samples) are received and how the tasks are carried out.

The system 100 utilises all round and multi level contrasts to decouple task invariant and task variant features in training sequences of continual learning tasks. The construction of inner task and cross task relations effectively extracts well defined and well distributed task invariant and task variant features. This improves the classification task and alleviates the forgetting problem in continual learning. The replay buffer used to define the cross relations assists in ameliorating the forgetting problem. The system 100 for modelling task features is proposed for use in continual learning models e.g., machine learning or AI models for continual learning. The system 100 improves the features quality in task invariant and task variant feature decomposition. One example application may be computer vision products.

In this example embodiment, the system and method for modelling task features for continual learning may be implemented by a computer (i.e., computing apparatus or computing system or computing device) having an appropriate processor, memory and user interface. The computer may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computer i.e., computing device may be appropriately programmed to implement the invention.

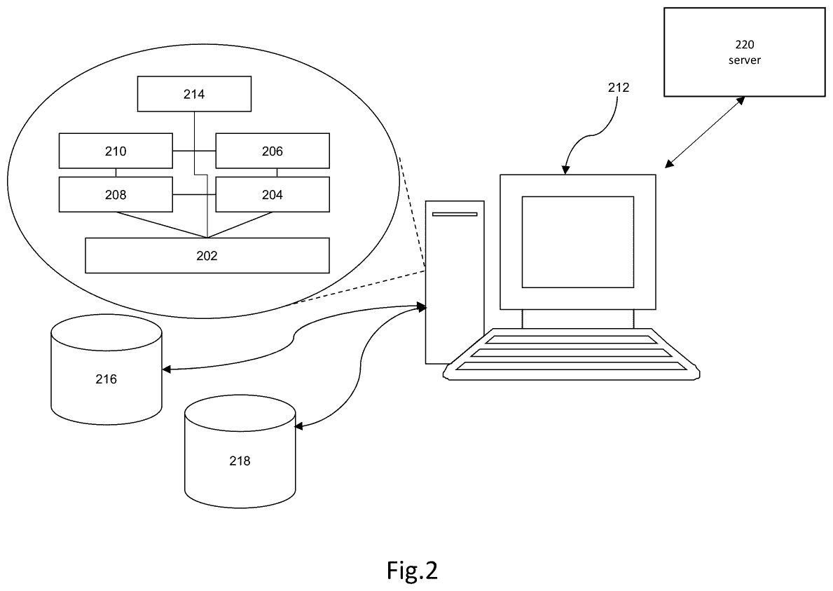

As shown in FIG. 2 there is a shown a schematic diagram of a computer i.e., a computing system or computing device 200 which is arranged to be implemented as an example embodiment of a system 100 for modelling task features for continual learning. The computing device 200 may be part of the system 100 for modelling task features for continual learning.

As shown in the illustrated embodiment, the system 100 may be implemented on a computer 200 which includes suitable components necessary to receive, store and execute appropriate computer instructions. The components may include a processing unit 202, including Central Processing Unit (CPU), Math Co-Processing Unit (Math Processor), Graphic Processing Unit (GPUs) or Tensor Processing Unit (TPUs) for tensor or multi-dimensional array calculations or manipulation operations, read-only memory (ROM) 204, random access memory (RAM) 206, and input/output devices such as disk drives 208, input devices 210 such as an Ethernet port, a USB port, etc. Optionally, the computer 200 may comprise a display 212 such as a liquid crystal display, a light emitting display or any other suitable display. The computer 200 may further include communications links 214 such as for example a WiFi network interface or a Bluetooth network interface or a cellular network interface. The network interfaces allow the computer 200 to communicate data using an appropriate communication network and protocols.

The computer 200 (i.e., system 100) may include instructions that may be included in ROM 204, RAM 206 or disk drives 208 and may be executed by the processing unit 202. There may be provided a plurality of communication links 214 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link.

The computing device 200 may include storage devices such as a disk drive 208 which may encompass solid state drives, hard disk drives, optical drives, magnetic tape drives or remote or cloud-based storage devices. The computing device 200 may use a single disk drive or multiple disk drives, or a remote storage service. The computer 200 (i.e., computing device 200) may also have a suitable operating system which resides on the disk drive or in the ROM.

Optionally, the computer may also provide the necessary computational capabilities to operate or to interface with a machine learning network, such as a neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time. The system 100 may used as part of a neural network or other AI model for continual learning. The system 100 and its functions may be used in processing data and learning. One or more neural network models or other machine learning models and associated libraries may be stored in a model database 216. Additionally, training data may be stored in a further training data database 218. The processor 202 may be configured to access the model from the model database 216 and use training data from the training data database 218 to train one or more models. The models may be alternatively stored in a memory unit e.g., ROM or RAM. The databases 216, 218 may be stored in a memory unit or a disk drive. The replay buffer as described above may be stored in a memory unit.

In another example the computing device 200 i.e., computing apparatus may be configured to communicate with a remote device or remote computing system or a remote server. One or more components of the system 100 may be stored remotely and may be accessed via a communication network. For example, the replay buffer 106 may be stored on a remote server 220 and may be accessed by the computing device 200 when the system 100 is being utilised.

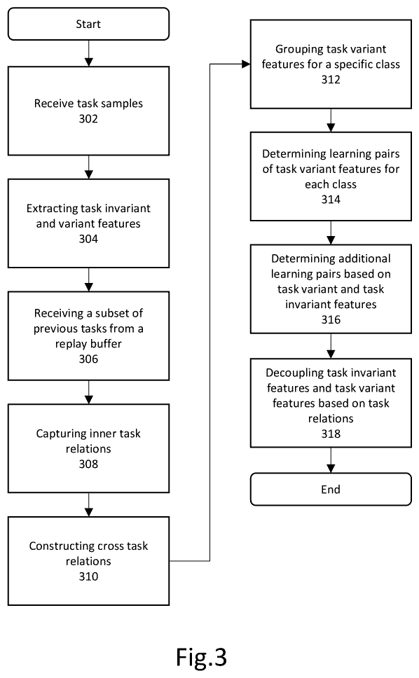

FIG. 3 illustrates a method 300 for modelling task features for continual learning. The method 300 may be implemented by the system 100 and its components. The method 300 may further be executed by the processing unit 202 of the computer 200 as the system is executing it. The method 300 for modelling task features for continual learning may be a computer implemented method for modelling task features.

The computer implemented method 300 comprises step 302. Step 302 comprises receiving one or more task samples. Step 304 comprises extracting task invariant features and task variant features from the received task samples. The step of extracting task invariant and task variant features comprises applying at least one or more constraints, wherein the constraints comprise at least one of:
establishing a boundary between the invariant and variant features
generating similar task invariant features across tasks
establishing distinct boundaries between task variant features from each task or class.

Step 306 comprises receiving a subset of previous tasks from a replay buffer. Step 308 comprises capturing inner task relations based on processing the task invariant and task invariant features. Step 310 comprises constructing cross task relations based on the subset of previous tasks accessed from the replay buffer.

Step 308 comprises determining the inner task relations based on the learning pairs that decouple the task invariant and task variant features while clustering the invariant features together regardless of class. Step 312 comprises grouping task variant features for a specific i.e., particular class together. Step 314 comprises determining learning pairs of task variant features for each defined class. Step 316 comprises determining additional updated learning pairs of task variant features, task invariant features, and task invariant and variant features based on the feature from the replay buffer. Step 310 for determining a cross task relations is based on the updated learning pairs. Step 318 comprises decoupling task invariant features and task variant features based at least one of the inner task relations and cross task relations. The method 300 may be repeated.

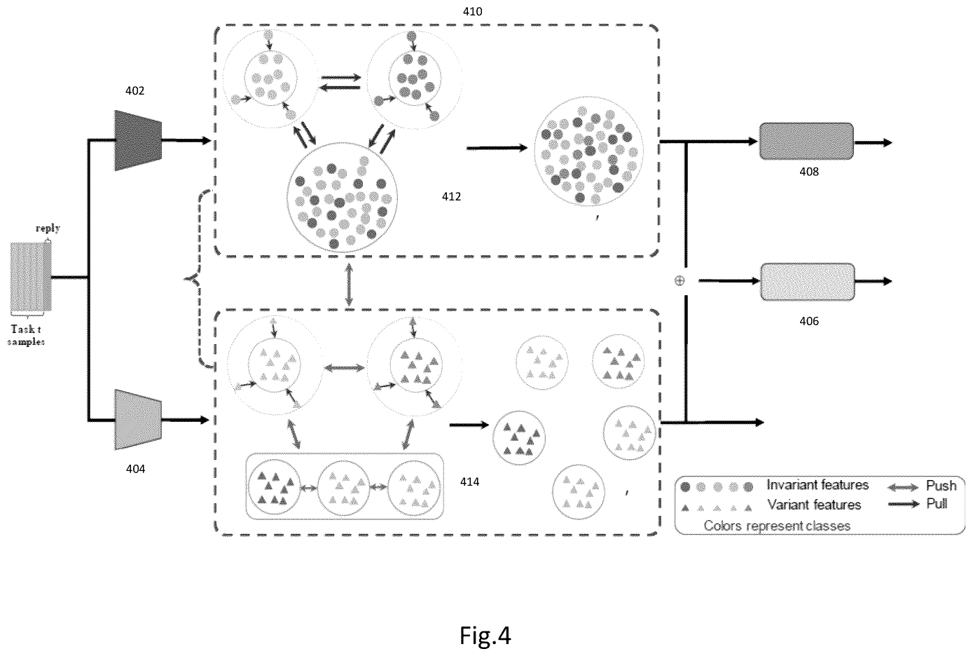

FIG. 4 illustrates a further example embodiment of a system 400 for modelling task features. The system 400 may be used for continual learning applications. The system 400 may be configured to implement the method 300. The system 400 may be utilised to model inner and cross task relations for continual learning.

The system 400 comprises a task invariant feature extractor 402 S, a task variant feature extractor 404 P and a classifier 406 C for each task. The variant feature extractor may be defined as P={P₁, P₂, . . . , Pₙ} and the classifier may be defined as C={C₁, C₂, . . . , Cₙ}. The system 400 further comprises a discriminator D 408.

The system 400 is configured to extract features from inputs using the task invariant feature extractor 402 and variant feature extractor 404, respectively. After feature extraction, a projection head is used to embed extracted features into the same latent space. This is mathematically defined as below:

$${x}_{s} = S ( {X}_{i} ) , {x}_{p} = P ( {X}_{i} ) \qquad ( 1 )$$

$${x}_{s}^{′} = SH ( {x}_{s} ) , {x}_{p}^{′} = PH ( {x}_{p} ) , \qquad ( 2 )$$

where SH(·) and PH(·) are the task-invariant feature and task-variant feature projection head. To enlarge the distance between task invariant and variant features in the latent space, an orthogonal distance loss [1] is used to constrain their representation, which is defined as:

$${L}_{d} = \sum {‖ {( {x}_{s}^{′} )}^{T} {x}_{p}^{′} ‖}_{F}^{2} , \qquad ( 3 )$$

where [symbol] ∥·∥_{F}² [symbol] denotes squared Frobenius norm.

However, only the orthogonal distance loss may not be sufficient for feature decomposition, since it only enlarges the distance of components, while some components of the invariant and variant features may have connections that are crucial for classification. Therefore, to investigate the inner-task relations between them and enhance feature decomposition, the KDC 410 is configured to combine the orthogonal distance loss with a task classification engine 410 i.e., a knowledge decomposition constraint (KDC) to decouple the invariant and variant features while preserving their essential connections.

The task classification engine 410 i.e., the KDC provides multiple constraints for extracting well-distributed task invariant and variant features. These constraints include: a) establishing a clear boundary between invariant and variant features, b) promoting the generation of similar task-invariant features across tasks, and c) ensuring distinct boundaries between task-variant features from each task or class.

The task classification engine 410 is configured to utilise the constraints and the orthogonal loss function L_{d} in the decomposition process, while enforcing the desired feature characteristics. A suitable network applying a supervised contrastive learning process e.g., SupCon may be applied to supervise the contrastive learning process. The contrastive learning process applied by the task classification engine 410 i.e., the KDC comprises introducing class labels for each instance. The KDC 410 is configured to use the aforementioned constraints on the task invariant and task variant features by constructing all around contrasts.

The task invariant and task variant features are required to be pushed apart in distance and make them dissimilar. The KDC 410 is configured to separate the invariant and variant features and distinguish them. L_{d} enlarges the feature distance while KDC 410 leverages the concept of contrastive learning pairs to model the relation in both aspects as a supplementary. The task classification engine 410 i.e., the KDC is configured to utilise the invariant features xₛ′ as anchors and construct negative pairs to xₚ′, to decouple the task invariant and task variant features. Additionally, recognizing that features from the same or different semantic class should have a similar effect. The KDC 410 further expands the margin between x_{{s,c=i}}′ and {x_{{p,c=i}}′, x_{{p,c≠i}}′}, where c represents the class label, that is to construct negative pairs between them. The negative pair set as np:

$$np = \{ ( {x}_{\{ s , c = i \}}^{′} , {x}_{\{ p , c = i \}}^{′} ) , ( {x}_{\{ s , c = i \}}^{′} , {x}_{\{ p , c \neq i \}}^{′} ) \} . \qquad ( 4 )$$

The KDC 410 i.e., the task classification engine 410 is further configured to use an adversarial loss function to force invariant features from all tasks and classes to be similar by similar. The adversarial loss function may be defined as:

$${L}_{d} = {min}_{SH} {max}_{D} \sum 1 * log ( D ( SH ( {x}_{s} ) ) ) , \qquad ( 5 )$$

where xₛ is task-invariant feature and SH(·) is the task-invariant feature projection head.

In order to further improve invariant features and minimize the distance between them, the relationship between invariant features of all classes within one task are modelled. The invariant features may be gathered regardless of the class label and the smaller the distance between them, the more similar they will be. Therefore, each two of invariant features should construct a positive pair. In this way, the positive pair set includes the following pairs, x_{{s,c=i}}′ and constructs positive pairs with {x_{{s,c=i}}′, x_{{s,c≠i}}′} which is written as pp:

$$pp = \{ ( {x}_{\{ s , c = i \}}^{′} , {x}_{\{ s , c = i \}}^{′} ) , ( {x}_{\{ s , c = i \}}^{′} , {x}_{\{ s , c \neq i \}}^{′} ) \} . \qquad ( 6 )$$

As they use the same anchors xₛ′, the KDC i.e., classification engine 410 combines np and pp as part of the constraint Lₛₚ. In this case, Lₛₚ can be formulated as:

$${L}_{sp} = {\sum }_{i ∈ I} \frac{- 1}{\vert pp \vert} {\sum }_{pp} \frac{exp ( {x}_{i}^{′} \cdot {x}_{pp}^{′} / τ )}{{\sum }_{a ∈ \{ pp , np \}} exp ( {x}_{i}^{′} \cdot {x}_{a}^{′} / τ )} , \qquad ( 7 )$$

where xₚₚ′ is the positive sample, I is all samples, pp is the positive pairs subset, |pp| is the total number of pp, and τ is the temperature index. This is illustrated in FIG. 4 by feature 412 that shows the task invariant features arranged in learning pairs.

To facilitate KDC 410 (i.e., task classification engine) with supervised information and gather the positive pairs between xₛ′, a 1 label is assigned to all xₛ′ regardless of their class labels, making them indistinguishable in the comparison. On the other hand, xₚ′ is assigned label 0, which decouples it from xₛ′ and pushes them apart for a clear margin. This term enhances the similarity among xₛ′ and investigates their inner-task relation when decoupling invariant and variant features. Variant features with clear class boundaries can improve classification task performance.

To achieve this, the classification engine 410 (KDC 410) constrains xₚ′ from the same class to be close while pushing apart those from different classes to get task-variant features with a clear boundary. Therefore, the learning pair set of variant features is denoted as vp. Considering the class label, vp includes the positive pairs set {x_{p,c=i}′, x_{p,c=j}′) when i=j, and negative pairs set {x_{pc=i}′, x_{p,c=j}′} when i≠j. The constraint on up is denoted as Lₚ, which is the same as Eq. (7). This is illustrated further in FIG. 4 as feature 414 that shows the task variant features being grouped and separated by class.

Previous methods neglected the cross-task relation resulting in a chaotic distribution of different tasks' variant features. The task classification engine 410 implements a replay based method. The engine 410 is configured to simultaneously input into the model, both replayed and current task samples, during training. Although treating replayed samples as current task samples helps alleviate forgetting, they do not directly contribute to the feature extraction of the current task. To mitigate the forgetting problem and enhance the robustness of feature extraction, the KDC is configured to consider the feature relation between the current task and the memory, that is the cross-task relation. The task classification engine 410 is configured to construct additional learning pairs that follow similar strategies used for inner-task relation construction and feature decomposition. Specifically, the learning pairs set np include extra learning pairs (x_{s,c=i}′, x_{p,m}′), pp includes (x_{s,c=i}′, x_{s,m}′) and vp includes negative pairs (x_{p,c=i}′, x_{p,m}′), where m represents feature from replay samples. The cross-task relation construction supplements the inner-task contrastive design with all-round contrastive learning pairs.

The KDC 410 incorporates a regularization term Lᵣ of the previous and current models to prevent the model parameter and the similarity between xₛ′ and xₚ′ from changing too rapidly, which may lead to the model collapse problem and make the model hard to train. The complete KDC loss term is defined as follows:

$${L}_{c} = {L}_{sp} + {L}_{p} + {L}_{r} . \qquad ( 8 )$$

The classifier 406 C is trained by the concatenation of xₛ′ and xₚ′ for each task, where the cross-entropy loss is used as the classification loss:

$${L}_{task} = - \sum log ( C ( concat ( {x}_{s}^{′} , {x}_{p}^{′} ) ) , Y ) , \qquad ( 9 )$$

where C is the task-specific classifier, and concat denotes the feature concatenation.

The objective function in the training process can be written as:

$$L = {λ}_{1} * {L}_{task} + {λ}_{2} * {L}_{d} + {λ}_{3} * {L}_{dis} + {λ}_{4} * {L}_{c} , \qquad ( 10 )$$

where λ is the hyperparameter for each item.

After training on one task, a small number of current task samples are randomly saved in the memory R. The variant features of replay samples do not calculate the gradient for the current task. Before training the next task, the KDC 410 is configured to randomly initialize task variant feature extractors Pᵢ and classifiers Cᵢ to replace previous Pᵢ₋₁ and Cᵢ₋₁, and randomly initialize the discriminator Dᵢ with one additional output neuron compared to Dᵢ₋₁. During the testing phase, the task-invariant feature extractor Sₙ replaces the previous invariant feature extractors {S₁, S₂, . . . , Sₙ₋₁} and it is used to extract task-invariant features for all testing samples.

The system and method for modelling task features for continual learning as described is particularly suited for use in machine learning applications. The system and method for modelling task features for continual learning may be used in supervised or unsupervised or semi-supervised learning applications or a combination thereof. The proposed system and method for continual learning may be applied in deep learning models. The system and method may also be applied in other learning models. The system for modelling task features improves feature quality in task invariant and task variant feature decomposition. The proposed system uses a replay buffer that includes a subset of previous tasks. The replay buffer is used to construct cross task relations which can alleviate the forgetting problems for machine learning models in continual learning. The continual learning model that is proposed by the system for task feature identification can be used in various continual learning applications, such as for example computer vision products.

The system 100 is advantageous because the system implements a method for continual classification task that effectively explores inner relations and cross task relations by constructing all around contrastive learning pairs. The system 100 is advantageous because it improves performance beyond the state of the art systems. The KDC 410 is also advantageous because the KDC utilises three types of contrasts to decompose generalised task invariant features and task variant features. The system 100 incorporates replay buffers with replay samples with contrastive constraints to alleviate the forgetting problem and model cross task relations.

The proposed task classification engine 410—(i.e., the KDC) is designed to use the contrastive learning method, described herein, to model the inner- and cross-task relation to get well-distributed task-invariant and variant features. This effectively improves the feature quality and the model performance on the continual learning task.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

1. A system for modelling task features for continual learning comprising:
a task input gateway arranged to receive a series of task samples,
a task feature extraction engine arranged to process the received task samples and extract task invariant and task variant features,
a replay buffer configured to store a subset of previous tasks as a representative of previous tasks that were processed by the system,
a task classification engine arranged to perform a task relation process to determine task relations between tasks, wherein the task relations are based at least partly on a subset of previous tasks accessed from the replay buffer.
an output module configured to output the task relations to be used on continual learning, and wherein the replay buffer is updated by storing a subset of the outputs.

2. A system as per claim 1, wherein the task classification engine is configured to decouple task invariant features and task variant features based on the task relations.

3. A system as per claim 1, wherein the task classification engine is configured to:
capture inner task relations based on processing the task invariant and task invariant features,
construct cross task relations based on the subset of previous tasks accessed from the replay buffer.

4. A system as per claim 1, wherein the task classification engine is configured to decouple task invariant features and task variant features based at least one of the inner task relations and cross task relations.

5. A system as per claim 2, wherein the system is configured to determine contrastive learning pairs, wherein the inner task relations and the cross task relations are defined by the determined contrastive learning pairs.

6. A system as per claim 3, wherein the task classification engine is configured to determine multiple contrasts to decompose task invariant features and task variant features.

7. A system as per claim as per claim 4, wherein the task classification engine is configured to determine three types of contrast to decompose task invariant features and task variant features.

8. A system as per claim 1, wherein the system further comprises:
a task invariant feature extractor configured to extract task invariant features from the received series of task samples,
a task variant feature extractor configured to extract task variant features from the received series of task samples.

9. A system as per claim 8, wherein the task classification engine is configured to:
extract task invariant and task variant features by applying at least one or more constraints wherein the constraints comprise:
establishing a boundary between the invariant and variant features
generating similar task invariant features across tasks
establishing distinct boundaries between task variant features from each task or class.

10. A system as per claim 6, wherein the task classification engine is configured to decouple the task invariant and task variant features based on:
determining an orthogonal distance loss function,
applying the orthogonal distance loss function to the identified task invariant and task variant features,
determining contrastive learning pairs of features,
utilise the learning pairs to further decouple the task invariant and task variant features.

11. A system as per claim 10, wherein the task classification engine is configured to determine inner task relations, wherein the inner task relations are determined based on the learning pairs that decouple the task invariant and task variant features while clustering the invariant features together regardless of class.

12. A system as per claim 10, wherein the task classification engine is further configured to:
apply a classifier to the task variant features wherein the classifier is configured to group task variant features for a particular class together,
determine learning pairs of task variant features for each defined class.

13. A system as per claim 10, wherein the task classification engine is configured to:
extract a feature of a sample of previous tasks from the replay buffer,
determine additional updated learning pairs of task variant features, task invariant features and task invariant and variant features based on the feature from the replay buffer,
determine a cross task relations based on the updated learning pairs.

14. A system as per claim 11, wherein the inner task relations are defined as an contrastive loss function, wherein the inner task relation function is:
$${L}_{sp} = {\sum }_{i ∈ I} \frac{- 1}{\vert pp \vert} {\sum }_{pp} \frac{exp ( {x}_{i}^{′} \cdot {x}_{pp}^{′} / τ )}{{\sum }_{a ∈ \{ pp , np \}} exp ( {x}_{i}^{′} \cdot {x}_{a}^{′} / τ )} ,$$
and;
wherein xₚₚ′ is the positive sample, I is all samples, pp is the positive pairs subset, |pp| is the total number of pp, τ is the temperature index and np is a negative pairs,
wherein pp is a set of learning pairs from task invariant features and np is a set of learning pairs between task invariant and task variant features.

15. A system as per claim 14, wherein the cross task relations are defined by learning pairs, wherein the learning pairs comprise np, pp, and vp, wherein np is a set of learning pairs between task invariant and task variant features, pp is a set of learning pairs from task invariant features, and vp represents learning pairs of task variant features, and;
wherein each set of learning pairs comprises additional terms,
np include extra learning pairs (x_{s,c=i}′, x_{p,m}′), pp includes (x_{s,c=i}′, x_{s,m}′) and vp includes negative pairs (x_{p,c=i}′, x_{p,m}′), wherein m represents a feature from the replay buffer.

16. A system as per claim 1, wherein the modelling task features comprise identifying task invariant and task variant features based on the inner task relations and cross task relations, wherein the system provides a model for learning based on resolving tasks into task invariant features and task variant features.

17. A system as per claim 1, wherein the system further comprises:
a classifier arranged to classify tasks based on a specific class
a discriminator arranged to discriminate the differentiate between the task invariant and variant features of each task.

18. A computer implemented method for modelling task features for continual learning comprising the steps of:
receiving one or more task samples,
extract task invariant and task variant features from the received task samples,
receiving a subset of previous tasks from a replay buffer,
performing a task relation process to:
capture inner task relations based on processing the task invariant and task invariant features,
construct cross task relations based on the subset of previous tasks accessed from the replay buffer, and;
decouple task invariant features and task variant features based at least one of the inner task relations and cross task relations.

19. A computer implemented method as per claim 18, wherein the method comprises the additional step of:
extracting task invariant and task variant features by applying at least one or more constraints wherein the constraints comprise:
establishing a boundary between the invariant and variant features
generating similar task invariant features across tasks
establishing distinct boundaries between task variant features from each task or class.

20. A computer implemented method as per claim 18, comprising:
determining the inner task relations based on the learning pairs that decouple the task invariant and task variant features while clustering the invariant features together regardless of class,
grouping task variant features for a particular class together,
determining learning pairs of task variant features for each defined class.
extracting a feature of a sample of previous tasks from the replay buffer,
determining additional updated learning pairs of task variant features, task invariant features and task invariant and variant features based on the feature from the replay buffer, and;
determining a cross task relations based on the updated learning pairs.
